(19) United States
(12) Patent Application Publication
(10) Pub. No.: US 2025/0341131 A1
(43) Pub. Date: Nov. 6, 2025

(54) METHOD FOR CONTROLLING AN ELECTROMECHANICAL ACTUATOR FOR A CONCEALMENT DEVICE AND ASSOCIATED ELECTROMECHANICAL ACTUATOR

(71) Applicant: SOMFY ACTIVITES SA, CLUSES (FR)

(72) Inventors: Cédric FERNANDEZ, Cluses (FR); Yoann DEZEUZE, Cluses (FR)

(21) Appl. No.: 19/193,126

(22) Filed: Apr. 29, 2025

(30) Foreign Application Priority Data
May 2, 2024 (FR) 2404615

(51) Int. Cl. E06B 9/72; E06B 9/42; H02J 7/00

(52) U.S. Cl. CPC E06B 9/72; E06B 9/42; H02J 7/00032; H02J 7/00714

(57) ABSTRACT

This method for controlling an electromechanical actuator comprising an electronic control unit (15) and a battery (18), the electronic control unit comprising a controller (31), connected to a charger (44) and to a charging circuit (32) of the battery (18), comprises:
detecting a charger connection to the electromechanical actuator,
when a connection is detected, determining a supply profile with an amperage threshold value,
controlling the charger, to supply the charging circuit with the power supply profile.

It further comprises a first control step, for charging the battery with an amperage of a charging current equal to a first amperage, and a second control step, for charging the battery with an amperage of the charging current equal to a second amperage, strictly greater than the first amperage and less than or equal to the amperage threshold value.

### FIELD

This invention relates to a method for controlling an electromechanical actuator for a concealment device, and to an associated electromechanical actuator.

### BACKGROUND

An electromechanical actuator for a closure, concealment, or solar protection device comprises an electronic control unit, a rechargeable battery, and an electric motor, the electric motor being powered by the rechargeable battery to set a screen of the closure, concealment or solar protection device in motion. The electronic control unit comprises a controller embedded in the electromechanical actuator adapted to be connected to a smart charger external to the electromechanical actuator via a communication bus, and a rechargeable battery charging circuit adapted to be connected to the smart charger via a power supply bus. When charging the rechargeable battery with the smart charger, the charging circuit is powered by the smart charger via the power supply bus to charge the rechargeable battery, and the embedded controller communicates with the smart charger via the communication bus to exchange data. However, if the data exchange takes place at the same time as the rechargeable battery is being charged, it is disrupted, in particular because of interference caused by electromagnetic disturbances, which reduces the quality of the data exchanged, or even renders it unreadable by the embedded controller and the smart charger. This effect is particularly pronounced when the current flowing through the power supply bus to charge the rechargeable battery is high, and/or the communication speed for exchanging data through the communication bus is high.

### SUMMARY

The aim of the invention is therefore to enable data exchange with minimal disruption, without interrupting the charging of the rechargeable battery.

To this end, the invention relates to a method for controlling an electromechanical actuator for a concealment device, the electromechanical actuator comprising at least:
an electronic control unit, and
a rechargeable battery,
   the electronic control unit comprising at least:
a controller, the controller being connected to a charger via a communication bus, the charger being external to the electromechanical actuator, and
a charging circuit, the charging circuit being, on the one hand, connected to the rechargeable battery and to the controller and, on the other hand, connected to the charger via a power supply bus,
   the method being implemented by the electronic control unit, the method comprising at least:
a step of detecting a connection between the charger and the electromechanical actuator,
when a connection of the charger to the electromechanical actuator is detected, a step of determining a supply profile capable of being supplied by the charger, the supply profile being characterised by a voltage threshold value associated with an amperage threshold value, and
a charger control step, so that the charger supplies the charging circuit with the determined supply profile.

According to the invention, the method further comprises at least:
a first step of controlling the charging circuit, so that the charging circuit charges the rechargeable battery with an amperage of a charging current equal to a first amperage for a predetermined duration, the first amperage being strictly less than the amperage threshold value, and
when the predetermined time has elapsed, a second step of controlling the charging circuit, so that the charging circuit charges the rechargeable battery with an amperage of the charging current equal to a second amperage, the second amperage being strictly greater than the first amperage and less than or equal to the amperage threshold value.

Thanks to the invention, the embedded controller and the smart charger can exchange data with each other, even while the rechargeable battery is being charged. During the predetermined period, the amperage of the charging current is equal to the first amperage level and is low enough to limit disruption to data exchanges. The communication is carried out for the predetermined time, in order to limit the time during which the rechargeable battery is charged by a charging current of amperage equal to the first amperage level, which results in slower charging than when the rechargeable battery is charged by a charging current of amperage equal to the second amperage level. This makes it possible to communicate between the embedded controller and the smart charger, while limiting the charging time.

In other beneficial aspects of the invention, the method comprises one or more of the following features, taken in isolation or in any technically possible combination.

The method further comprises a step of communicating with the charger via the communication bus, so as to implement an exchange of data between the controller and the charger, the communication step being carried out for the predetermined duration.

The communication bus is a high-speed communication bus, the data exchange being implemented at a speed in a range between 200 kHz and 400 kHz, in particular at a speed of 300 KHz.

The data exchanged between the controller and the charger during the communication step is PowerDelivery data from the USB PowerDelivery standard.

The detection step comprises at least:
a sub-step of monitoring the presence of a power supply signal on the power supply bus,
during the monitoring sub-step, a first sub-step of detecting the presence of the power supply signal on the power supply bus,
in response to detecting the presence of the power supply signal, a first sub-step of communicating from the charging circuit to the controller at least one item of information indicating the presence of the power supply signal, and
in response to receiving the information indicating the presence of the power supply signal, a second sub-step of detecting, by the controller, the presence of a resistance value on the communication bus,
   the monitoring sub-step and first detection sub-step being implemented by the charging circuit, and the second detection sub-step being implemented by the controller.

The step of determining the supply profile further comprises at least:
a sub-step of receiving a list of supply profiles, the list of supply profiles being transmitted by the charger; and
a sub-step of selecting the supply profile from the list of supply profiles,
   the reception and selection sub-steps being carried out by the controller.

When the charger is connected to the electromechanical actuator, the charger automatically supplies the charging circuit with a minimum supply profile, the minimum supply profile being distinct from and strictly lower than the supply profile determined in the determination step,
and, when the detection and determination steps are carried out, the charging circuit is not controlled to charge the rechargeable battery.

The invention also relates to an electromechanical actuator for a concealment device, the electromechanical actuator comprises at least:
an electronic control unit, and
a rechargeable battery,
   the electronic control unit comprising at least:
a controller, the controller being adapted to be connected to a charger via a communication bus, the charger being external to the electromechanical actuator, and
a charging circuit, the charging circuit being, on the one hand, connected to the rechargeable battery and to the controller and, on the other hand, adapted to be connected to the charger via a power supply bus.

According to the invention, the electronic control unit is configured to implement the steps of the method.

In other beneficial aspects of the invention, the electromechanical actuator comprises one or more of the following features, taken in isolation or in any technically possible combination.

The electromechanical actuator further comprises a connector, and the connector comprises at least:
a communication pin, the communication pin being connected to the controller via the communication bus, and
a power supply pin, the power supply pin being connected to the charging circuit via the power supply bus.

The connector is a universal serial bus Type-C connector.

The electromechanical actuator further comprises an electric motor, the electric motor being electrically connected to the rechargeable battery so as to be powered in operation by the rechargeable battery.

### BRIEF DESCRIPTION OF THE DRAWINGS

The invention will appear more clearly when reading the description that follows, given solely as a non-limiting example and made in reference to drawings in which:

FIG. 1 is a view of a concealment device according to one embodiment of the invention;

FIG. 2 is a view of an electromechanical actuator according to one embodiment of the invention;

FIG. 3 is a view of a torque support of an electromechanical actuator according to one embodiment of the invention;

FIG. 4 is an electrical diagram of an electromechanical actuator according to one embodiment of the invention; and
FIG. 5 is a flowchart of a method for controlling an electromechanical actuator according to one embodiment of the invention.

### DETAILED DESCRIPTION

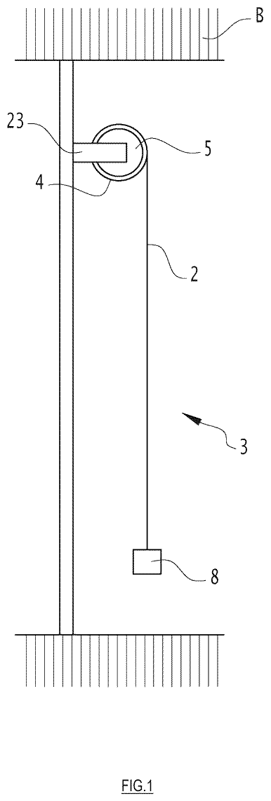

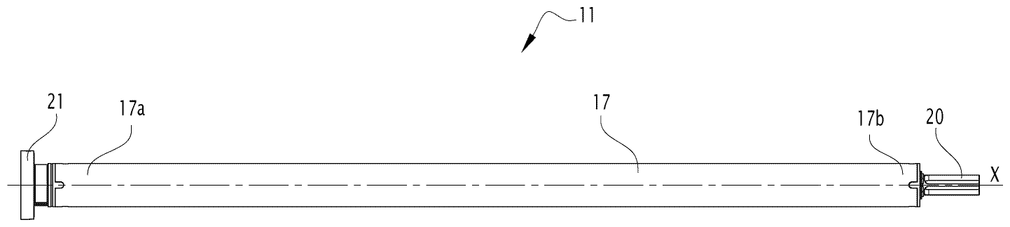

Firstly, with reference to FIG. 1, a concealment or solar protection device 3 is described. The concealment or solar protection device is hereafter referred to as the “concealment device”.

The concealment device 3 can be a blind, in particular a blind with a roll-up fabric, a pleated or honeycombed fabric, or a blind with adjustable slats. This invention is applicable to all types of concealment devices.

The concealment device 3 comprises a motorised driving device 5 for a screen 2, the motorised driving device 5 being positioned at an opening in a building B to move the screen 2 relative to the opening in the building B. The concealment device 3 comprises the screen 2.

15 The screen 2 is made, for example, of a roll-up fabric, or of a pleated or honeycombed fabric, or of adjustable slats.

The motorised driving device 5 further comprises an electromechanical actuator 11 illustrated in FIG. 2.

The concealment device 3 further comprises a winding tube 4. The screen 2 can be rolled onto the winding tube 4. In addition, the winding tube 4 is arranged to be rotated by the electromechanical actuator 11.

Thus, the screen 2 of the concealment device 3 is rolled onto the winding tube 4 or unwound around it, the winding tube 4 being driven by the motorised driving device 5, in particular by the electromechanical actuator 11.

Thus, the screen 2 can be moved between a rolled position, in particular a high position, and an unrolled position, in particular a low position.

The screen 2 of the concealment device 3 is a concealment and/or solar protection screen which can be wound and unwound around the winding tube 4, the inner diameter of which is greater than the outer diameter of the electromechanical actuator 11, so that the electromechanical actuator 11 can be inserted into the winding tube 4 when the concealment device 3 is assembled.

The concealment device 3 further comprises a load bar 8 for exerting tension on the screen 2. A first end of the screen 2, particularly the upper end of the screen 2, in an assembled configuration of the concealment device 3, is fixed to the winding tube 4. Furthermore, a second end of the screen 2, particularly the lower end of the screen 2, in the assembled configuration of the concealment device 3, is fixed to the load bar 8.

The electromechanical actuator 11, in particular a tubular one, allows the winding tube 4 to be rotated about an axis of rotation X, so that the screen 2 of the concealment device 3 can be moved, in particular unrolled or rolled.

In the installed state of the concealment device 3, the electromechanical actuator 11 is inserted into the winding tube 4.

The concealment device 3 comprises a holding device 23. The holding device 23 may comprise two supports. The supports are arranged at one end of the winding tube 4, in particular in the assembled configuration of the concealment device 3. Thus, the winding tube 4 is held by the supports. The supports allow the concealment device 3 to be mechanically connected to the structure of the building B, in particular to a wall the building B.

The electromechanical actuator 11 is now described with reference to FIGS. 2 to 4.

The electromechanical actuator 11 comprises an electronic control unit 15, an electric motor 16 and a rechargeable battery 18. The electronic control unit 15 is connected to the rechargeable battery 18 and to the electric motor 16.

The electromechanical actuator 11 further comprises a casing 17, in particular a hollow tubular one. The electric motor 16 is mounted inside the casing 17, in particular in an assembled configuration of the electromechanical actuator 11.

The rechargeable battery 18 is mounted inside the casing 17, in particular in the assembled configuration of the electromechanical actuator 11.

Alternatively, not shown in the figures, the rechargeable battery 18 is external to the electromechanical actuator 11, in which case the rechargeable battery 18 is connected to the electronic control unit 15 via a power cable. The casing 17 comprises a first end 17a and a second end 17b. The second end 17b is opposite the first end 17a. Here, the casing 17 of the electromechanical actuator 11 is cylindrical in shape, in particular rotationally symmetrical about the axis of rotation X, and is open at each of its ends 17a, 17b.

The electromechanical actuator 11 further comprises an output shaft 20. The output shaft 20 is arranged, i.e. is configured to be arranged, on the side of the second end 17b of the casing 17, in particular in the assembled configuration of the electromechanical actuator 11.

The electromechanical actuator 11 further comprises a gearbox. The gearbox is coupled, i.e. is configured to be coupled, with the electric motor 16 in the assembled configuration of the electromechanical actuator 11.

The electromechanical actuator 11 further comprises a brake. The brake is configured to brake and/or rotationally lock the output shaft 20 so as to regulate the rotational speed of the winding tube 4 when the screen 2 is moved, and to keep the winding tube 4 locked, when the electric motor 16 is electrically deactivated.

The gearbox, and potentially, the brake are mounted inside the casing 17 of the electromechanical actuator 11, in particular in the assembled configuration of the electromechanical actuator 11.

The electromechanical actuator 11 further comprises a ring, in other words, a sleeve. The ring is configured to be arranged, i.e. is arranged, at the first end 17a of the casing 17, in particular in the assembled configuration of the electromechanical actuator 11.

The ring forms, i.e. is configured to form or constitute, a guide bearing guiding the rotation of the winding tube 4 around the casing 17 of the electromechanical actuator 11, in particular in an assembled configuration of the motorized driving device 5 and, consequently, of the concealment device 3.

The winding tube 4 is rotated around the axis of rotation X and the casing 17 of the electromechanical actuator 11 and is supported by two pivot connections. The first pivot connection is made at a first end of the winding tube 4 by means of the ring arranged around the first end 17a of the casing 17 of the electromechanical actuator 11. The ring thus makes it possible to create a bearing. The second pivot connection is made at a second end of the winding tube 4, opposite the first end.

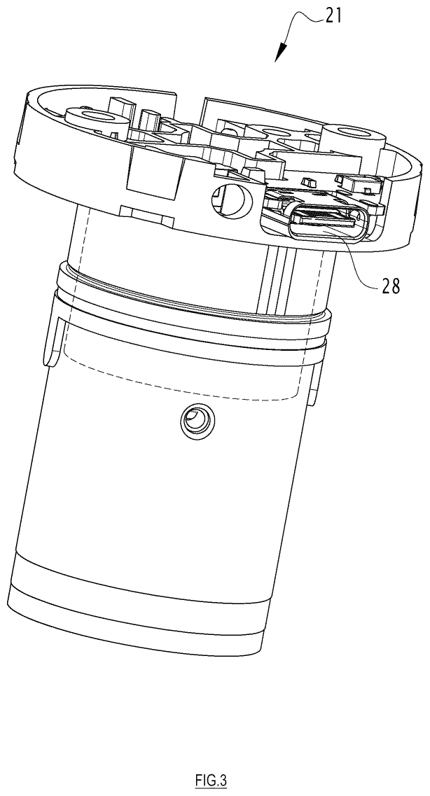

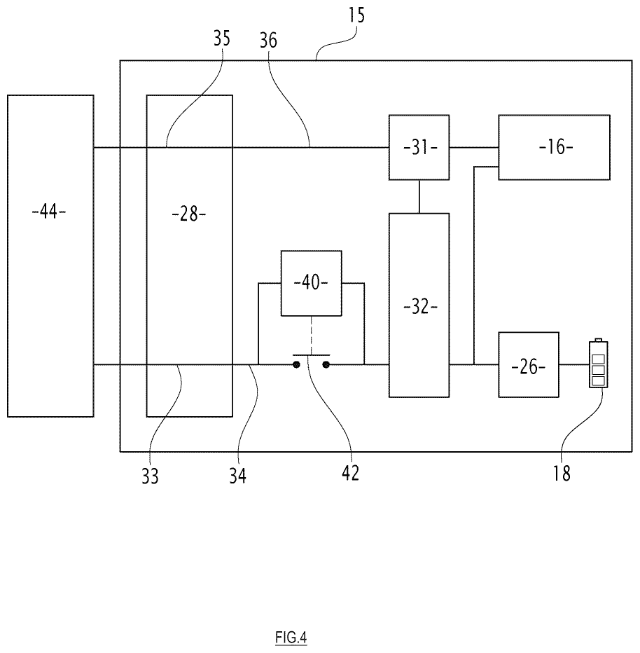

The electromechanical actuator 11 further comprises a torque support 21, which may also be called the “actuator head” or “fixed point”. One embodiment of the torque support 21 is illustrated in FIG. 3.

Here, the torque support 21 is arranged on the first end 17a of the casing 17 of the electromechanical actuator 11, in particular in the assembled configuration of the electromechanical actuator 11.

The torque support 21 of the electromechanical actuator 11 is configured to attach the electromechanical actuator 11 to the holding device 23, in particular to one of the supports.

Thus, the torque support 21 makes it possible to absorb the load applied by the electromechanical actuator 11, in particular the torque exerted by the electromechanical actuator 11 relative to the structure of the building B. Advantageously, the torque support 21 also allows the load applied by the winding tube 4, in particular the weight of the winding tube 4, the electromechanical actuator 11 and the screen 2, to be taken up and to ensure that this load is absorbed by the structure of the building B.

The torque support 21 protrudes from the first end 17a of the casing 17 of the electromechanical actuator 11.

Thus, a first part of the torque support 21 is arranged inside the casing 17 and a second part of the torque support 21 is arranged outside the casing 17.

The torque support 21 closes off, i.e. is configured to close off, the first end 17a of the casing 17, in particular in the assembled configuration of the electromechanical actuator 11.

In addition, the torque support 21 of the electromechanical actuator 11 can support at least part of the electronic control unit 15.

The torque support 21 is configured to be fixed, i.e. is fixed to the casing 17 by means of one or more fastening elements, not shown, in particular in the assembled configuration of the electromechanical actuator 11. The fastening element(s) may be, for example, bosses, fastening screws, elastic snap-in fastening elements, ribs in indentations, or a combination thereof.

In a first embodiment, not shown, the ring is arranged, i.e. is configured to be arranged, around part of the casing 17, in particular in the assembled configuration of the electromechanical actuator 11. In this case, the ring is mounted to rotate freely around the casing 17.

Alternatively, not shown, the ring is arranged, i.e. is configured to be arranged, around the torque support 21, in particular in the assembled configuration of the electromechanical actuator 11. In this case, the ring is mounted to rotate freely around the torque support 21.

In a variant, not shown, the ring is arranged, i.e. is configured to be arranged, on the one hand, around the torque support 21, and, on the other hand, around part of the casing 17, in particular in the assembled configuration of the electromechanical actuator 11. In such a case, the ring can be mounted to rotate freely, on the one hand, around the torque support 21 and, on the other hand, around the casing 17.

The output shaft 20 of the electromechanical actuator 11 is arranged inside the winding tube 4 and at least partly outside the casing 17 of the electromechanical actuator 11.

Here, one end of the output shaft 20 protrudes from the casing 17 of the electromechanical actuator 11, in particular from the second end 17b of the casing 17.

Advantageously, the output shaft 20 of the electromechanical actuator 11 is configured to rotate, i.e. rotates, a connecting element, also called a “wheel”. This connecting element is connected to the winding tube 4, in particular in the assembled configuration of the concealment device 3.

When the electromechanical actuator 11 is switched on, the electric motor 16 and the gearbox rotate the output shaft 20. In addition, the output shaft 20 of the electromechanical actuator 11 rotates the winding tube 4 via the connecting element. Thus, the winding tube 4 rotates the screen 2 of the concealment device 3, so that the opening 1 of the building B is opened or closed.

With reference to FIG. 4, the electronic control unit 15 of the electromechanical actuator 11 is now described.

The electronic control unit 15 is arranged, i.e. is integrated, inside the casing 17 of the electromechanical actuator 11.

The electronic control unit 15 comprises a controller 31 embedded in the electromechanical actuator 11, and a circuit 32 for charging the rechargeable battery 18.

The charging circuit 32 is connected to the controller 31 and to the rechargeable battery 18.

The electronic control unit 15 comprises at least one electronic board on which the charging circuit 32 and the controller 31 are assembled, the electronic board being arranged, in other words integrated, inside the casing 17 of the electromechanical actuator 11 in the assembled configuration of the electromechanical actuator 11.

The rechargeable battery 18 is configured to supply the electromechanical actuator 11, in particular the electronic control unit 15 and the electric motor 16, with electrical power.

Advantageously, the rechargeable battery 18 is of the Ni-MH type, or of the Lithium-ion type.

The controller 31 is, for example, a microcontroller. Here, and by way of a non-limiting example, the controller 31 is an STM32G0B1CE microcontroller.

In one embodiment of the motorised driving device 5, the controller 31 in particular contains a combination of software components, commonly known as a USB Power Delivery stack, also known as a USB-PD stack.

The electromechanical actuator 11 advantageously comprises a management module 26 for the rechargeable battery 18, connected between the rechargeable battery 18 and the charging circuit 32.

The electromechanical actuator 11 advantageously comprises a connector 28. The connector 28 comprises a power supply pin 33, connected to charging circuit 32 by a power supply bus 34, and a communication pin 35 connected to the controller 31 by a communication bus 36, visible in FIG. 4. Advantageously, the connector 28 is a universal serial bus (USB) type C connector, also known as USB-C.

Advantageously, the power supply bus 34 and the communication bus 36 are included in the same flexible flat cable (FFC) ribbon. The FFC mat is at least 1 cm long, for example, and the cables included in the FFC ribbon are unshielded.

Advantageously, the electromechanical actuator 11 further comprises a protection module 40. In the example shown in FIG. 4, the protection module 40 is connected in parallel with a switch 42 located on the power supply bus 34. The protection module 40 is configured to control the switch 42. When the switch 42 is open, the connection between the power supply pin 33 and the charging circuit 32 is interrupted.

A smart charger 44, shown in FIG. 4, is configured to be connected to the electromechanical actuator 11. The smart charger 44 is external to the electromechanical actuator 11.

The smart charger 44 is, for example, a smart charger connected to an electrical power supply source, for example the mains, or is an auxiliary power unit, for example another battery external to the electromechanical actuator 11 allowing electronic devices to be recharged without using an electrical socket, the auxiliary power unit in this case being commonly referred to as a “Power Bank”.

The smart charger 44 comprises hardware and software elements adapted to communicate with the controller 31 of the electromechanical actuator 11 via the communication bus 36.

In general, the smart charger 44 is configured by default to supply the power supply bus 34 with a minimum supply profile PDO_min. The smart charger 44 is further capable of providing, i.e. is configured to provide, a list of supply profiles PDO_N via the communication bus 36. The smart charger 44 is also configured to negotiate with the controller 31, via the communication bus 36, a supply profile PDO from the list of supply profiles PDO_N. In other words, the smart charger 44 is configured to supply, on command from the controller 31, a supply profile PDO selected by the controller 31 from the list of supply profiles PDO_N.

Generally speaking and within the meaning of the invention, a power supply profile is characterised by a voltage threshold value U associated with an amperage threshold value I. The power supply profile is commonly referred to as U/I, for example 5V/500 mA, 6V/2 A, 15V/1 A, etc.

According to an embodiment of the smart charger 44, the smart charger 44 comprises hardware and software elements compatible with, in other words configured to implement, the “USB Power Delivery” standard, also known as “USB-PD”, in particular the “USB Power Delivery 3.0” standard, also known as “USB-PD 3.0”.

According to one embodiment of the smart charger 44, the smart charger 44 is a smart charging station configured to charge the rechargeable battery 18 of the electromechanical actuator 11, and to configure the electromechanical actuator 11, or to update software elements of the electronic control unit 15 of the electromechanical actuator 11, or to configure the electromechanical actuator 11 and update software elements of the electronic control unit 15 of the electromechanical actuator 11. In this embodiment, the smart charging station comprises hardware and software elements adapted to communicate to the controller 31, via the communication bus 36, data for configuring the electromechanical actuator, or data for updating the software elements of the electronic control unit 15, or data for configuring the electromechanical actuator 11 and for updating the software elements of the electronic control unit 15.

Advantageously, the electromechanical actuator 11 is configured to be connected to the smart charger 44 via the connector 28. If the connector 28 is a USB-C connector, the smart charger 44 is a USB-C charger with “Power Delivery” functionality.

The controller 31 is configured to control the charging circuit 32, and to charge the rechargeable battery 18 from the smart charger 44.

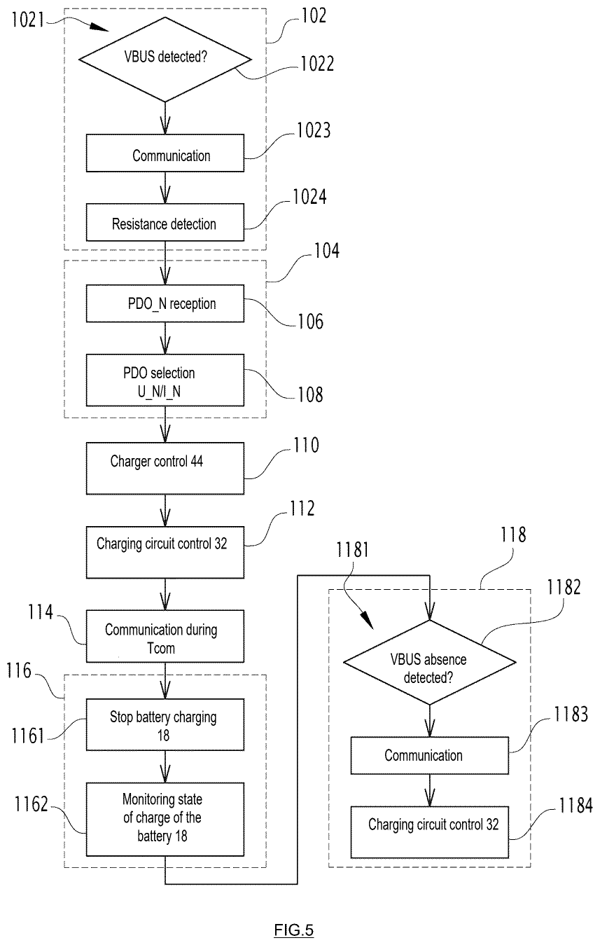

With reference to FIG. 5, a method for controlling the electromechanical actuator 11 is now described. The method is implemented by the electronic control unit 15, with at least some of the steps of the method being implemented by the controller 31.

The control method comprises a step 102 of detecting a connection of the smart charger 44 to the electromechanical actuator 11.

Advantageously, the detection of the connection of the smart charger 44 to the electromechanical actuator 11 is performed by detecting the connection of the smart charger 44 to the connector 28.

Advantageously, when the smart charger 44 is connected to the electromechanical actuator 11, the smart charger 44 automatically supplies the charging circuit 32, via the power supply bus 34, with a minimum supply profile PDO_min. In other words, the smart charger 44 provides by default, in other words is configured to provide by default, a minimum supply profile PDO_min via the power supply bus 34.

The minimum power supply profile PDO_min is characterised by a minimum voltage threshold value U_min associated with an amperage threshold value I_min. In one embodiment of the smart charger 44, the minimum power supply profile PDO_min is characterised by a minimum voltage threshold value U_min equal to 5 volts associated with a minimum amperage threshold value I_min equal to 500 milliamperes, the minimum power supply profile PDO_min in this case being denoted 5V/500 mA.

Advantageously, the detection step 102 comprises at least:
a sub-step of monitoring 1021 the presence of a power supply signal VBUS on the power supply bus 34,
during the monitoring sub-step 1021, a first sub-step of detecting 1022 the presence of the power supply signal VBUS on the power supply bus 34,
in response to detecting the presence of the power supply signal VBUS, a first sub-step of communicating 1023 from the charging circuit 32 to the controller 31 at least one item of information indicating the presence of the power supply signal VBUS, and
in response to receiving the information indicating the presence of the power supply signal VBUS, a second sub-step of detecting 1024, by the controller 31, the presence of a resistance value on the communication bus 36.

The monitoring sub-step 1021 and first detection sub-step 1022 are implemented by the charging circuit 32, and the second detection sub-step 1024 is implemented by the controller 31.

Advantageously, when implementing the detection step 102, the power supply signal VBUS is formed by the smart charger 44 from the minimum supply profile PDO_min.

Thus, the detection step 102 enables the controller 31 to be informed via the charging circuit 32 of the presence of the power supply signal VBUS on the power supply bus 34, and in response to detect the presence of the resistance value on the communication bus 36, the presence of the resistance value indicating to the controller 31 the possibility of exchanging messages with the smart charger 44 via the communication bus 36.

When a connection of the smart charger 44 to the electromechanical actuator 11 is detected, the control method further comprises a step of determining 104 a supply profile PDO capable of being supplied by the smart charger 44. The supply profile PDO is characterised by a voltage threshold value U_N associated with an amperage threshold value I_N, and is denoted U_N/I_N.

Advantageously, the minimum supply profile PDO_min is distinct from and strictly lower than the supply profile PDO determined during the determination step 104. In other words, the value of the minimum voltage threshold U_min is distinct from and strictly less than the value of the voltage threshold U_N determined during the determination step 104, and the value of the minimum amperage threshold I_min is distinct from and strictly less than the value of the amperage threshold I_N determined during the determination step 104.

Advantageously, the determination step 104 further comprises at least:
a sub-step of reception 106, by the controller 31, of a list of supply profiles PDO_N, the list of supply profiles PDO_N being transmitted by the smart charger 44, and
a sub-step of selection 108, by the controller 31, of the supply profile PDO from the list of power supply profiles PDO_N.

Here, and as previously described, the list of supply profiles PDO_N comprises a plurality of supply profiles PDO1, PDO2, . . . , PDON capable of being supplied by the smart charger 44. Such a list comprises, for example, the following supply profiles: 5V/500 mA, 6V/2 A, 15V/1 A, and may comprise additional or different profiles.

Advantageously, the profile selected during the selection sub-step 108 is suitable for charging the rechargeable battery 18 via the charging circuit 20.

Advantageously, the list of supply profiles PDO_N is transmitted by the smart charger 44 to the controller 31 via the communication pin 35 and the communication bus 36.

Advantageously, the supply profile PDO selected during the selection sub-step 108 is selected with respect to a predetermined supply profile, the predetermined supply profile being stored in a memory of the controller 31. The predetermined supply profile is, for example, chosen by a manufacturer of the electromechanical actuator 11.

Advantageously, the supply profile PDO selected during the selection step 108 is equal to 15V/1 A, this supply profile making it possible to charge the rechargeable battery 18 of the electromechanical actuator 11 efficiently.

Alternatively, the supply profile PDO selected in the selection sub-step 108 is selected from the list of supply profiles PDO_N by comparison with a predetermined supply profile stored in a memory of the controller 31, so as to have the greatest similarity to the predetermined supply profile. For example, the supply profile selected is the one with the voltage closest to the voltage of the predetermined supply profile, or the current closest to the predetermined supply profile. In another example, the similarity between the supply profiles in the supply profile PDO_N list and the predetermined supply profile is calculated based on both the voltage threshold value and the amperage threshold value of the supply profiles.

Alternatively, a list of authorised supply profiles, ranked in order of priority, is stored in advance in a memory of the controller 31, for example during manufacture of the electromechanical actuator 11, and the controller 31 selects from the list of supply profiles PDO_N provided by the smart charger 44 a supply profile PDO with the highest priority.

Advantageously, when the detection 102 and determination 104 steps are carried out, the charging circuit 32 is not controlled to charge the rechargeable battery 18. In this way, the rechargeable battery 18 is not charged by the charging circuit 20 until the controller 31 has selected a suitable supply profile for charging the rechargeable battery 18.

The control method further comprises a step 110 of controlling the smart charger 44, so that the smart charger 44 supplies the charging circuit 32 with the supply profile PDO determined in the determination step 104, for example with the 15V/1 A supply profile. In the control step 110, the controller 31 communicates the determined supply profile PDO to the smart charger 44 via the communication bus 36 and the communication pin 35.

Once the control step 110 has been carried out, in other words once the controller 31 has controlled the smart charger 44 to supply the charging circuit 20 with the determined supply profile PDO, the controller 31 implements a first step 112 of controlling the charging circuit 32, so that the charging circuit 32 charges the rechargeable battery 18 with an amperage of a charging current equal to a first amperage I_1 for a predetermined duration Tcom, the first amperage I_1 being strictly less than the amperage threshold value I_N. Thus, the charging circuit 32 charges the rechargeable battery 18 for the predetermined duration Tcom with an amperage lower than the amperage of the power supply profile PDO commanded to the smart charger 44 by the controller 31 during the control step 110. In this way, the current flowing through the power supply bus 34 during the predetermined time Tcom is minimised, without being zero, thus enabling electromagnetic disturbances between the power supply bus 34 and the communication bus 36 to be minimised while starting to slowly charge the rechargeable battery 18. For example, the first amperage I_1 is equal to 100 mA.

Advantageously, the predetermined duration Tcom is calculated from the instant when the charging circuit 32 is supplied by the smart charger 44 with the supply profile PDO in response to the control step 110 of the smart charger 44. The predetermined time Tcom is advantageously on the order of a few minutes, for example two minutes.

Advantageously, the control method further comprises a communication step 114, for the predetermined time Tcom, with the smart charger 44 via the communication bus 36, so as to enable an exchange of data between the controller 31 and the smart charger 44.

Advantageously, the communication bus 36 is a high-speed communication bus, the data exchange being implemented at a speed in a range between 200 kHz and 400 kHz, in particular at a speed of 300 KHz.

Advantageously, the data is “PowerDelivery” type data from the “USB Power Delivery” standard, also known as “USB-PD”, in particular from the “USB Power Delivery 3.0” standard, also known as “USB-PD 3.0”.

Alternatively, the data exchanged is data for configuring the electromechanical actuator 11, or data for updating the software elements of the electronic control unit 15, or data for configuring the electromechanical actuator 11 and for updating the software elements of the electronic control unit 15.

When the predetermined time Tcom has elapsed, the controller 31 implements a second step 116 of controlling the charging circuit 32, so that the charging circuit 32 charges the rechargeable battery 18 with an amperage of a charging current equal to a second amperage I_2, the second amperage I_2 being strictly greater than the first amperage I_1.

Advantageously, the second amperage I_2 is equal to the amperage threshold value I_N of the determined supply profile PDO. For example, the second amperage I_2 is equal to 1.5 A when the supply profile PDO determined by the determination step 104 is the 15V/1.5 A supply profile.

In the second control step 116, the charging circuit 32 is still connected to the smart charger 44 and supplied by the smart charger 44 with the supply profile PDO determined in the determination step 104. In this way, the rechargeable battery 18 is charged more quickly than during the predetermined time Tcom, because the charging circuit 32 charges the rechargeable battery 18 with an amperage strictly greater than the amperage charging the rechargeable battery during the predetermined time Tcom.

Advantageously, the second control step 116 further comprises a stop sub-step 1161 for charging the rechargeable battery 18, the stop step 1161 being implemented by the charging circuit 32 so that the charging circuit 32 stops charging the rechargeable battery 18 with the second amperage I_2 when a value of a charge level of the rechargeable battery 18 reaches or exceeds a charging threshold value.

Advantageously, the second control step 116 further comprises a monitoring sub-step 1162, the monitoring sub-step 1162 being implemented by the charging circuit 32 following the stop sub-step 1161, so that the charging circuit 32 monitors the value of the charge level of the rechargeable battery 18, and if the value of the charge level is strictly less than the charging threshold value, the charging circuit 32 charges the rechargeable battery 18 again with the second amperage I_2.

Advantageously, the control method further comprises a second step of detecting 118 a disconnection of the smart charger 44 from the electromechanical actuator 11.

Advantageously, the second detection step 118 comprises at least:
a sub-step of monitoring 1181 the presence of a power supply signal VBUS on the power supply bus 34,
during the monitoring sub-step 1181, a sub-step of detecting 1182 the absence of the power supply signal VBUS on the power supply bus 34,
in response to detecting the presence of the power supply signal VBUS, a first sub-step of communicating 1183 from the charging circuit 32 to the controller 31 at least one item of information indicating the presence of the power supply
In response to receiving the information indicating the absence of the VBUS power supply signal, a sub-step of controlling 1184 the charging circuit 32 so that the charging circuit 32 stops charging the rechargeable battery 18.

The monitoring sub-step 1181 and detection sub-step 1182 are implemented by the charging circuit 32, and the control sub-step 1184 is implemented by the controller 31.

The method is advantageously implemented each time a connection from the smart charger 44 to the electromechanical actuator 11 via the connector 28 is detected by the controller 31.

Advantageously, in the event of an electrical fault between the smart charger 44 and the charging circuit 32, for example in the event of a short-circuit or overcurrent, the protection module 40 commands the switch 42 to open, in order to protect the charging circuit 32.

Advantageously, in the event of an electrical fault or malfunction of the rechargeable battery 18, for example if the temperature of the rechargeable battery 18 is too high, the management module 26 of the rechargeable battery 18 interrupts the connection between the charging circuit 32 and the rechargeable battery 18, to avoid damaging the rechargeable battery 18.

Advantageously, the controller 31 further comprises hardware and software means adapted to control the electric motor 16.

Advantageously, the controller 31 further comprises a command order reception module, the command order reception module being potentially wired or wireless. The movement order comes, for example, from a remote control that a user operates to move the screen 2. Waiting a predetermined duration during which the rechargeable battery 18 is charged by a charging current of the first amperage level enables the communication step 114 to take place without the risk of the signals exchanged on the communication bus 36 being disturbed or even rendered unreadable, which would make communication on the communication bus 36 impossible. This also makes it possible to use an unshielded FFC ribbon between the connector 28, the charging circuit 32 and the controller 31, thereby reducing the cost of the electromechanical actuator 11 without reducing the quality of the communication and without completely interrupting the charging of the rechargeable battery 18 for the predetermined time Tcom.

Any feature described for one embodiment or variant in the foregoing may be implemented for the other embodiments and variants described above, insofar as technically feasible.

1. A method for controlling an electromechanical actuator for a concealment device, the electromechanical actuator comprising at least:
an electronic control unit, and
a rechargeable battery,
the electronic control unit comprising at least:
a controller, the controller being connected to a charger via a communication bus, the charger being external to the electromechanical actuator, and
a charging circuit, the charging circuit being, on the one hand, connected to the rechargeable battery and to the controller and, on the other hand, connected to the charger via a power supply bus,
the method being implemented by the electronic control unit, the method comprising at least:
a step of detecting a connection between the charger and the electromechanical actuator,
when a connection of the charger to the electromechanical actuator is detected, a step of determining a supply profile capable of being supplied by the charger, the supply profile having a voltage threshold value associated with an amperage threshold value, and
a step of controlling the charger, so that the charger supplies the charging circuit with the determined supply profile,
wherein the method further comprises at least:
a first step of controlling the charging circuit, so that the charging circuit charges the rechargeable battery with an amperage of a charging current equal to a first amperage for a predetermined duration, the first amperage being strictly less than the amperage threshold value, and
when the predetermined time has elapsed, a second step of controlling the charging circuit, so that the charging circuit charges the rechargeable battery with an amperage of the charging current equal to a second amperage, the second amperage being strictly greater than the first amperage and less than or equal to the amperage threshold value.

2. The method according to claim 1, further comprising a step of communicating with the charger via the communication bus, so as to implement an exchange of data between the controller and the charger, the communication step being carried out for the predetermined duration.

3. The method according to claim 2, wherein the communication bus is a high-speed communication bus, the data exchange is implemented at a speed in a range between 200 kHz and 400 kHz, in particular at a speed of 300 KHz.

4. The method according to claim 2, wherein the communication bus is a high-speed communication bus, the data exchange is implemented at a speed of 300 KHz.

5. The method according to claim 2, wherein the data exchanged between the controller and the charger, during the communication step, is data of the PowerDelivery type of the USB PowerDelivery standard.

6. The method according to claim 1, wherein the detection step comprises at least:
a sub-step of monitoring the presence of a power supply signal on the power supply bus,
during the monitoring sub-step, a first sub-step of detecting the presence of the power supply signal on the power supply bus,
in response to detecting the presence of the power supply signal, a first sub-step of communicating from the charging circuit to the controller at least one item of information indicating the presence of the power supply signal, and
in response to receiving the information indicating the presence of the power supply signal, a second sub-step of detecting, by the controller, the presence of a resistance value on the communication bus,
the monitoring sub-step and first detection sub-step being implemented by the charging circuit, and the second detection sub-step being implemented by the controller.

7. The method according to claim 1, wherein the step of determining the supply profile further comprises at least:
a sub-step of receiving a list of supply profiles, the list of supply profiles, being transmitted by the charger; and
a sub-step of selecting the supply profile from the list of supply profiles,
the reception and selection sub-steps being carried out by the controller.

8. The method according to claim 1, wherein, when the charger is connected to the electromagnetic actuator, the charger automatically supplies the charging circuit with a minimum supply profile, the minimum supply profile being distinct from and strictly lower than the supply profile determined in the determination step, and wherein, when the detection and determination steps are carried out, the charging circuit is not controlled to charge the rechargeable battery.

9. An electromechanical actuator for a concealment device, the electromechanical
rechargeable battery,
the electronic control unit comprising at least:
a controller, the controller being connected to a charger via a communication bus, the charger being external to the electromechanical actuator, and
a charging circuit, the charging circuit being, on the one hand, connected to the rechargeable battery and to the controller and, on the other hand, adapted to be
wherein the electronic control unit is configured to implement the steps of the method according to claim 1.

10. The electromechanical actuator according to claim 9, further comprising a connector, the connector comprising at least:
a communication pin, the communication pin being connected to the controller via the communication bus, and
a power supply pin, the power supply pin being connected to the charging circuit via the power supply bus.

11. The electromechanical actuator according to claim 10, wherein the connector is a universal serial bus type C connector.

12. An electromechanical actuator according to claim 9, the electromechanical actuator further comprising an electric motor, the electric motor being electrically connected to the rechargeable battery so as to be powered in operation by the rechargeable battery.
